(19) United States
(12) Patent Application Publication
(10) Pub. No.: US 2015/0169217 A1
(43) Pub. Date: Jun. 18, 2015

(54) CONFIGURING TOUCHPAD BEHAVIOR THROUGH GESTURES

(71) Applicant: CIRQUE CORPORATION, Salt Lake City, UT (US)

(72) Inventor: Joshua Konopka, Salt Lake City, UT (US)

(73) Assignee: CIRQUE CORPORATION, SALT LAKE CITY, UT (US)

(21) Appl. No.: 14/572,467

(22) Filed: Dec. 16, 2014

Related U.S. Application Data
(60) Provisional application No. 61/916,356, filed on Dec. 16, 2013.

(51) Int. Cl. G06F 3/0488

(52) U.S. Cl. CPC G06F 3/04883

(57) ABSTRACT

A system and method for configuring pre-programmed features of a touch and proximity sensor by using touch and/or proximity gestures to activate a receiving mode of the touch and proximity sensor, perform a gesture to activate or deactivate a pre-programmed feature, and then terminating the receiving mode to return the touch and proximity sensor to a normal mode of operation.

### BACKGROUND OF THE INVENTION

1. Field of the Invention

This invention relates generally to touch sensors. Specifically, the invention pertains to capacitance sensitive touch and proximity sensors that can perform touch and proximity sensing of one or more objects, and the ability to configure features of a touch and proximity sensor through the use of gestures.

2. Description of Related Art

There are several designs for capacitance sensitive touch sensors. It is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can be replaced just by repurposing the X or Y electrodes 12, 14. While one set of electrodes function as drive electrodes, the other set of electrodes function as the sense electrodes. The roles are then reversed in order to sense the position of an object in the other axis.

### BRIEF SUMMARY OF THE INVENTION

The present invention is a system and method for configuring pre-programmed features of a touch and proximity sensor by using touch and/or proximity gestures to activate a receiving mode of the touch and proximity sensor, perform a gesture to activate or deactivate a pre-programmed feature, and then terminating the receiving mode to return the touch and proximity sensor to a normal mode of operation.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

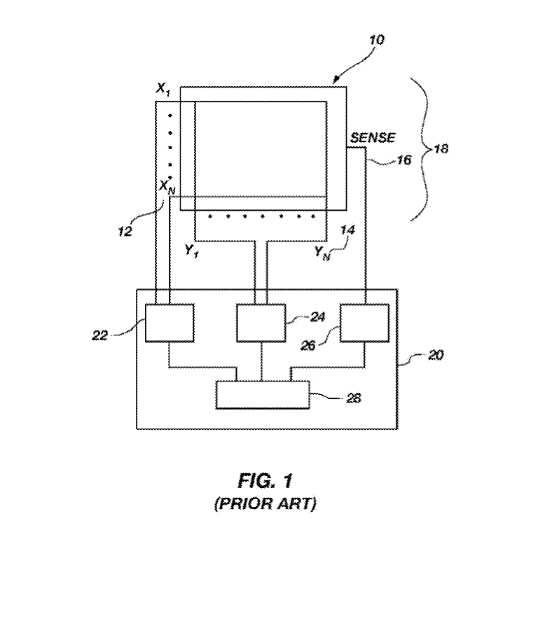

FIG. 2 is a flowchart showing the steps in a first embodiment of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “proximity sensor”, “touch sensor”, “touch and proximity sensor”, “touch panel”, “touchpad” and “touch screen”.

The present invention is directed to improving operation of a touch sensor that is also capable of operating as a proximity sensor. A touch sensor may be limited to only detecting objects that make physical contact with a touch sensitive surface. However, in the present invention, a touch sensor is combined with the ability to sense one or more objects before they make contact with the touch sensor, and may be referred to in this document as a touch and proximity sensor.

Having established that a touch and proximity sensor (hereinafter a “touch sensor”) may perform gestures that may be operated through touch, in a three-dimensional space using proximity sensing above the touch sensor, or a combination of touch and proximity sensing actions, the purpose of the present invention is to provide a touch sensor that may be configured through touch and/or proximity gestures.

Touch sensors may be used in many different electronic appliances. With the proliferation of electronic appliances that may include a touch sensor, it may be difficult to configure a touch sensor because a software or firmware drive may not be available that is otherwise available when the touch sensor is attached to a computing device such as a laptop or desktop computer. When attached to a computing device, the user of the touch sensor may have available all of the features that are typically included with an Operating System. But when attached to other devices, an Operating System may not be provided for the touch sensor. In this case, the user may only have available operations that are native or programmed into the touch sensor without the added features provided by an Operating System. There may be limited options for a user who desires to customize operation of the touch sensor and use pre-programmed native features or modes of operation of the touch sensor.

In the present invention, a user may desire to control pre-programmed native features or more simply “pre-programmed features” that are stored within the touch sensor. For example, the pre-programmed features may be stored in firmware of the touch sensor. While these pre-programmed features may be present in the touch sensor, the user may then need a way to activate and deactivate these features.

A method for activating and deactivating pre-programmed features may be to use gestures that can be recognized by the touch sensor. Gestures for activating and deactivating, or enabling and disabling pre-programmed feature, may be touch gestures, three-dimensional proximity gestures or a combination of touch and proximity gestures. Furthermore, these gestures may involve a single pointing object such as a finger, or they may be multi-finger or object gestures.

When using gestures for activating and deactivating for pre-programmed features, it may be preferable to use gestures that are unlikely to be performed accidentally. Another important aspect is that the gestures should not be so similar to gestures that might be used by a touch sensor that does not have the pre-programmed features of the present invention. This may cause confusion or errors.

For example, if the touch sensor may be plugged into and used with a computing device, a gesture of the touch sensor that is identical with a gesture of the Operating System may result in two functions being activated by the same gesture, or the conflicting gestures may cause an error in the computing device.

Thus, in order to avoid accidental activation and deactivation of pre-programmed features or activation of different modes of operation of the touch sensor, it would appear that the gestures would have to be considered to be very different from existing or commonplace gestures that already have an accepted use or meaning by other touch sensors, and thus less likely to be performed by accident.

This problem of having to avoid the use of commonplace and easy to remember gestures may be solved by the embodiments of the present invention. There may be two methods that a gesture may be used to activate and deactivate a pre-programmed feature of the touch sensor. The first method may be that the gesture is simply performed without any preparation of the touch sensor. Thus, whenever a gesture is performed that is pre-programmed to activate or deactivate a nature feature, activation or deactivation will occur.

In a first embodiment of the present invention, a second method for activating or deactivating a pre-programmed feature may be to have a preliminary step wherein the touch sensor is instructed that the next gesture to be performed is for the purpose of activating or deactivating pre-programmed features.

Both of these methods may be available for use by the touch sensor, for example, by operating in a particular mode of operation. In a first mode of operation, the touch sensor accepts an activation or deactivation gesture any time the touch sensor is in use. However, in a second mode of operation and in the first embodiment of the invention, the touch sensor requires an instruction that tells it that the next gesture performed will be for the specific purpose of activating or deactivating a pre-programmed feature.

While the first mode of operation may have the advantage of being quicker, it may also be activated unintentionally and more easily. Furthermore, all the gestures that are used must be very unique and different from commonplace gestures, which may also make them more difficult to remember.

In contrast, the second mode of operation which is the first embodiment may have the advantage that simple and easy to remember gestures may be used to activate or deactivate the pre-programmed features.

For example, the second mode of operation of the touch sensor may require a single and very unique or obscure gesture to be activated. The single unique or obscure gesture should be selected so that it is unlikely to be mistakenly performed by a user. Thus, instead of having to invent many different unique and obscure gestures that are unlikely to be mistakenly performed, only one must be chosen. All subsequent gestures that activate and deactivate pre-programmed features may be common, simple gestures that are not difficult for the user to remember or to perform.

Thus, by making the signal a very obscure gesture for the activation signal, more familiar gestures may then be used to actually activate or deactivate features or functions of the touch sensor. Therefore, the first embodiment of the present invention is a two-step process.

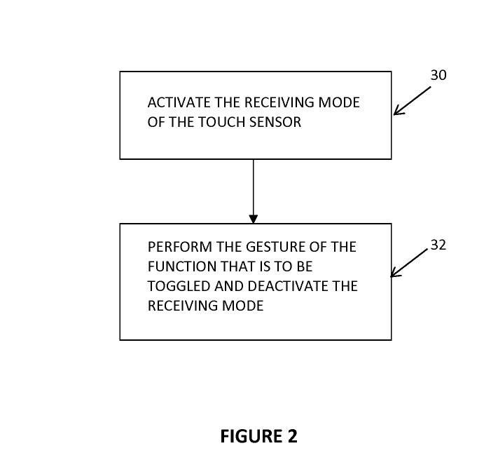

The first step of the first embodiment shown in FIG. 2 may be to perform a gesture that puts the touch sensor in a receiving mode. The receiving mode is activated so that an immediately subsequent gesture may be used to indicate that a pre-programmed feature or function of the touch sensor is going to be activated or deactivated.

Once the touch sensor is in the receiving mode, the next step may be to perform a gesture that is associated with activation or deactivation of a specific pre-programmed feature of the touch sensor.

The gesture associated with the specific pre-programmed feature to be activated or deactivated may be the same gesture. Thus, the gesture may function as a toggle to move back and forth between activation and deactivation. If the pre-programmed feature is already activated, then performing the gesture may deactivate the function. Likewise, if the function is deactivated, then performing the gesture again may result in the function being activated.

After the gesture is performed, the touch sensor exits or terminates the receiving mode. The touch sensor may return to a normal state of operation. Alternatively, the touch sensor may remain in the receiving mode until a gesture is performed that terminates the receiving mode of operation. Terminating the receiving mode may require another unique gesture or repeating the gesture that activated the receiving mode of the touch sensor.

In a second embodiment of the present invention, the gesture that is used to activate a pre-programmed feature may be assigned to be the gesture of the function that is being activated. In other words, the first step may be to put the touch sensor into the receiving mode. The second step may be to perform the gesture for the function that is desired.

For example, consider a zoom function. The user may first perform a gesture to activate the receiving mode of the touch sensor. The zoom gesture cannot yet be performed by the touch sensor by performing a zoom gesture. The second step may then be to perform the zoom gesture on the touch sensor while operating in the receiving mode. By performing the zoom gesture in the receiving mode, the touch sensor is instructed to activate the zoom gesture when the receiving mode is terminated. When the zoom gesture is recognized by the touch sensor in the receiving mode, the zoom function is activated or toggled on.

In an alternative embodiment, the user may not perform the gesture of the function to be activated or deactivated, but instead performs some other gesture. For example, a simple and easy to remember gesture may be used to toggle a pre-programmed feature on and off.

It is another feature of the embodiments of the invention that as soon as the gesture is performed in the second step to activate or deactivate the pre-programmed feature, the touch sensor may terminate the receiving mode and return to normal operation.

If a gesture was performed in the receiving mode, and the touch sensor requires that the gesture to be activated be performed in the receiving mode, then repeating the gesture may result in the pre-programmed feature being performed. Thus, if a zoom function was activated by performing the zoom gesture in the receiving mode, immediately repeating the zoom gesture may result in the touch sensor performing the zoom function.

In the embodiments of the present invention, the gesture that may be performed for the touch sensor to enter the receiving mode may be referred to as a secret handshake. Any desired gesture may be performed as the secret handshake. For example, the touch sensor may be pre-programmed to accept a unique gesture that requires a combination of fingers that are not commonly used together in any gesture. For example, the secret handshake may be two consecutive four-finger down swipes. Thus, the secret handshake which activates the receiving mode may be one or more discrete gestures. A complicated or uncommon gesture that is unlikely to be performed accidently may be the preferred method for activating the receiving mode. If the gesture requires more than one type of gesture then the odds of being activated accidentally may substantially decrease.

The example above should not be considered as limiting, but only as an example of an obscure gesture or combination of gestures that may be used to activate the receiving mode of the touch sensor.

In the previous embodiments of the present invention, no visual feedback is required in order to enter the receiving mode or to activate or deactivate the gesture. In an alternative embodiment, the present invention may use visual feedback as a guide. In other words, some adjustments being made may require visual feedback. For example, it may be desired to change a function of another peripheral device that is attached to a computing device. For example, the user may want to change a level of mouse acceleration on a computer mouse. The touch sensor is being used to modify a function of a device that is not the touch sensor itself. The mouse pointer shown on a display may be used to indicate the current acceleration level by moving back and forth with either a varying rate of movement, or a varying distance or some other visual indication.

The present invention may be especially useful in an environment where the pre-programmed features of a touch sensor may only be disposed within firmware. The pre-programmed features may reside only in the touch sensor itself, with the Operating System failing to provide other higher level or higher end pre-programmed features that the touch sensor may provide in its own firmware.

In a basic form of the first embodiment, a touch sensor is being used that has a memory for storing a plurality of pre-programmed features. The plurality of pre-programmed features may be stored in firmware or other appropriate hardware. In FIG. 2, a block diagram illustrates that in a first step 30 a receiving mode may activated in the touch sensor. The next step 32 may be to perform a gesture that activates or deactivates a pre-programmed feature of the touch sensor. In order to use that pre-programmed feature, the touch sensor must return to a normal mode of operation by terminating the receiving mode of operation, which may be done automatically after performing the gesture that activates or deactivates the pre-programmed feature.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for configuring pre-programmed features of a touch sensor, said method comprised of:
providing a touch sensor having memory for storing a plurality of pre-programmed features;
entering a receiving mode of operation; and
activating or deactivating a pre-programmed feature from the plurality of pre-programmed features stored in the touch sensor by performing a gesture.

2. The method as defined in claim 1 wherein the method further comprises the step of terminating the receiving mode of the touch sensor after activating or deactivating the pre-programmed feature.

3. The method as defined in claim 1 wherein the method further comprises:
providing a touch sensor that may also perform proximity sensing; and
including the option of performing touch gestures, proximity gestures, or a combination of touch and proximity gestures in order to activate the receiving mode or activating or deactivating the pre-programmed feature.

4. The method as defined in claim 1 wherein the method further comprises performing single finger or multi-finger gestures in order to activate the receiving mode or activating or deactivating the pre-programmed feature.

5. The method as defined in claim 4 wherein the method further comprises performing single step or multi-step gestures in order to activate the receiving mode or activating or deactivating the pre-programmed feature.

6. The method as defined in claim 1 wherein the method further comprises activating or deactivating a pre-programmed feature of a device that is not the touch sensor.

7. The method as defined in claim 1 wherein the method further comprises entering the receiving mode of operation by performing a gesture.

8. The method as defined in claim 1 wherein the step of activating or deactivating the pre-programmed feature further comprises performing the gesture for the pre-programmed feature that is being activated in order to activate or deactivate the pre-programmed feature.

9. The method as defined in claim 1 wherein the step of activating or deactivating the pre-programmed feature further comprises toggling the pre-programmed feature on and off by performing the gesture.

10. A method for configuring pre-programmed features of a touch and proximity sensor, said method comprised of:
providing a touch and proximity sensor having memory for storing a plurality of pre-programmed features;
entering a receiving mode of operation by performing a gesture; and
activating or deactivating a pre-programmed feature from the plurality of pre-programmed features stored in the touch sensor by performing a gesture.

11. The method as defined in claim 10 wherein the method further comprises the step of terminating the receiving mode of the touch sensor after activating or deactivating the pre-programmed feature.

12. The method as defined in claim 10 wherein the method further comprises performing touch gestures, proximity gestures, or a combination of touch and proximity gestures in order to activate the receiving mode or activating or deactivating the pre-programmed feature.

13. The method as defined in claim 10 wherein the method further comprises performing single finger or multi-finger gestures in order to activate the receiving mode or activating or deactivating the pre-programmed feature.

14. The method as defined in claim 13 wherein the method further comprises performing single step or multi-step gestures in order to activate the receiving mode or activating or deactivating the pre-programmed feature.

15. The method as defined in claim 10 wherein the method further comprises activating or deactivating a pre-programmed feature of a device that is not the touch sensor.

16. The method as defined in claim 10 wherein the method further comprises entering the receiving mode of operation by performing a gesture.

17. The method as defined in claim 10 wherein the step of activating or deactivating the pre-programmed feature further comprises performing the gesture for the pre-programmed feature that is being activated in order to activate or deactivate the pre-programmed feature.

18. The method as defined in claim 10 wherein the step of activating or deactivating the pre-programmed feature further comprises toggling the pre-programmed feature on and off by performing the gesture.
